(19) United States
(12) Patent Application Publication
(10) Pub. No.: US 2014/0113075 A1
(43) Pub. Date: Apr. 24, 2014

(54) METHOD FOR OBTAINING AN OBJECT HAVING A PRINTED THREE-DIMENSIONAL SURFACE

(71) Applicants: Rene Maillot, Jonchery Sur Vesle (FR); Eric Perraud, Courdimanche (FR)

(72) Inventors: Rene Maillot, Jonchery Sur Vesle (FR); Eric Perraud, Courdimanche (FR)

(73) Assignee: KEM ONE, Lyon (FR)

(21) Appl. No.: 14/008,432

(22) PCT Filed: Mar. 29, 2012
(86) PCT No.: PCT/EP2012/055691

§ 371 Date: Dec. 11, 2013

(30) Foreign Application Priority Data
Mar. 31, 2011 (FR) 1152668

(51) Int. Cl. B41M 3/00

(52) U.S. Cl. CPC B41M 3/00
USPC 427/256

(57) ABSTRACT

The present invention relates to a method for printing onto a stationary surface, e.g. a molded, three-dimensional, plasticized thermoplastic resin part, which enables a high-quality printed surface to be produced

The present invention relates to a method for printing on a fixed surface, for example a molded part based on plasticized thermoplastic resin, in three dimensions, with which a printed surface of great quality may be obtained.

In the automotive field, the preparation of composite layers or skins based on thermoplastic resin having a colored portion is known. These composite skins are used for the most visible portions of passenger compartments of automobile vehicles, such as in particular dashboards, central consoles and door trims. The presence of a colored portion gives the possibility of obtaining the most diverse visual effects such as an imitation of leather.

In order to obtain a surface having a colored portion on composite skins, two methods exist in particular. The first method [symbol] in mold painting [symbol] or [symbol] in mold pigmentation [symbol] (IMP), described in document EP 0 912 312 of the applicant comprises the following steps:
depositing on the surface of a mold, a colored composition A, comprising at least one plasticizer and optionally one or several coloring agents, such as coloration pigments, decorative flakes or a thermoplastic resin of the PVC type,
then depositing a composition B comprising a thermoplastic resin such as PVC,
heating the mold.

The second method, called [symbol] in mold coating [symbol] (IMC), is described in its principle in document WO 2004/060627, as well as in the document published under the number of U.S. Pat. No. 6,656,596. This document describes the obtaining of a panel for an automobile interior, having a multilayer structure obtained by successively depositing in a mold, a coating comprising an aqueous dispersion, or in a solvent for a polyurethane, a coloring agent and a cross-linking agent, and a layer containing polyvinyl chloride (PVC) and at least one plasticizer.

The methods described above however only give the possibility of obtaining objects of uniform color, and are therefore unsuitable when it is sought to produce fine colored patterns or very jaggedly cut colored shapes. Indeed, the colored compositions applied in the methods defined above, because of their rheological properties notably, can only be projected on a support by using paint guns. The diameter of the orifice through which the colored compositions are projected being large in the case of a paint gun, the printing accuracy is reduced and it is difficult to generate certain patterns such as fine lines, and in particular dotted lines.

Therefore there exists a need for a novel method for printing on a fixed three-dimensional surface with which it is possible to obtain for example molded objects based on plasticized thermoplastic resin, having a printed surface of great quality.

Thus, the invention relates to a method for obtaining an object having a printed three-dimensional surface, said method comprising at least one step (a) for driving an ink jet printing assembly, said printing assembly being equipped with displacement and orientation means along several axes, and with at least one means for controlling these means, and characterized in that said ink is an ink composition comprising, based on, the total weight of the composition, 5 to 20%, and preferably 10 to 15% of at least one thermoset or thermoplastic resin, the particles of which have a size comprised between 0.1 and 10 μm.

As a preamble, it will be noted that the expression [symbol] comprised between [symbol] should be interpreted in the present description as including the cited limits.

### Ink Jet Printing Assembly

The ink jet printing assembly applied in the method subject of the invention comprises a device providing ink as well as at least one printing head. The printing head may produce ink drops continuously or batchwise. Production of ink drops in a continuous flow may be carried out for example by maintaining a pressure above atmospheric pressure within the device providing ink.

Conversely, production of ink drops in a discontinuous flow, i.e. upon demand is carried out by means of a physical process having the result of momentarily suppressing the surface tension forces which maintain the ink in the printing head. The ink is actually maintained in the printing head while forming a meniscus, and remains in place until a force will momentarily reduce the surface tension inherent to the liquids, for example by electrostriction by means of a piezoelectric device. Preferably, the ink jet printing assembly comprises at least one piezoelectric printing head allowing printing by projecting ink drops on demand.

The ink jet printing assembly may also comprise 2, 3, 4 printing heads or more, allowing printing of different colors such as cyan, magenta, yellow, black, and optionally violet, red, brown, and white. The printing may be achieved with opaque or transparent pigments or coloring agents, selected according to the color of the actual support.

Preferably, the printing heads have a diameter of less than or equal to 40 μm and preferably comprised between 20 μm and 30 μm. As an example mention may be made of the use of Omnidot® 760 GS8 printing heads from XAAR, Cambridge, United Kingdom.

The ink is provided to the printing head by means of a supply device having the purpose of conditioning the latter with view to printing.

This supply device allows degassing of the ink and/or control of the pressure in the printing head. Indeed it is known that the presence of air bubbles in the chamber of a printing head, notably piezoelectric printing head, may cause problems during printing. The air bubbles actually annihilate the action of the piezoelectric transducers on the meniscus formed by the ink in the printing head. As piezoelectric transducers have an action comprised in a frequency range from kHz to MHz, the presence of air even in dissolved form in the ink may have detrimental consequences on the printing.

In order to avoid this type of problem, gas separators may equip the ink supplying device, for example devices as described in document EP0714779.

Another important point is the measurable pressure at the [symbol] nose [symbol] or tip of the printing head, which has to be finely controlled in order to obtain quality printing. Preferably, this pressure is slightly negative. In order to obtain this result, it is for example possible to generate a difference in height between the ink supplying device and the printing head. Thus, the ink supplying device appears in the form of a reservoir, the upper portion of which is open, so that the free surface of the ink in the reservoir is found at a few centimeters above the printing head. This difference then generates a difference in hydrostatic pressure. In a preferred embodiment of the invention, the ink supplying device is not found in close proximity to the printing head but is connected to the latter via tubes.

During printing, the printing head may undergo significant accelerations and decelerations, which may generate pressure waves within the reservoir, the printing head, the connection tubes and therefore at the meniscus. In order to avoid this type of problem, regulation devices, in the form of buffers for example may equip the ink jet printing system; on this subject, mention may for example be made of the document published under number EP 1120257 and the document published under the number U.S. Pat. No. 6,485,137.

For accelerations of more than 1G, devices as described in the document published under the number EP 1 142 713 may be used.

### Mixing Device

The ink jet printing assembly may be further equipped with a device for mixing the composition intended to be used as an ink. There is no restriction as regards the type of mixing device which may be used, from the moment that the latter consists of a material compatible with the ink composition. The mixing device may be placed in different locations of the printing system, for example close to the printing head or even within the printing head. As an example, the mixing device may be placed in a carriage in close proximity to the printing head, and moving simultaneously with the latter.

In an embodiment of the invention, the mixing device simply consists of tubes providing the different raw materials of the ink composition, gathering up in a single tube, and forming [symbol] Us [symbol] or [symbol] Ws [symbol] in order to improve the mixing.

The mixing device may also consist of a mixing chamber, pumps and/or valves. Alternatively, the mixing system may be replaced with simple stirring with which it is possible to avoid any sedimentation.

### Unit for Controlling the Ink Jet Printing Assembly

The ink jet printing assembly may be connected to a control unit allowing opening and closing of valves, controlling the flows with pumps, the speed of rotation of optional mixers.

The control unit also gives the possibility of storing and recording data relating to the mixing operations carried out for making the ink composition. The control unit may also be used for forming a [symbol] pattern [symbol] or [symbol] test pattern [symbol] or a prerecorded pattern giving the possibility of testing different ink compositions. For example with this, a digital library may be formed, associating one type of ink with one printing quality and therefore improving productivity.

### Displacement and Orientation Means

As indicated above, the ink jet printing assembly is equipped with displacement and orientation means along several axes.

In a first embodiment, means control the displacement of the ink jet printing assembly, and more particularly of the printing heads, along three axes. This displacement along three axes gives the possibility of maintaining a constant distance between the surface to be painted and said heads. This embodiment is advantageous because of its simplicity of application, industrially. However, in this embodiment, the heads follow the profile of the surface to be painted and do not change their orientation for keeping parallelism with the surface, so that only tracking in depth is achieved. This implies that in certain locations, the distance with the surface to be painted is different when several printing heads equip the ink jet printing assembly. Further, the incidence of the direction of the ink projection relatively to the surface may significantly vary, because of the three-dimensional structure of the latter.

In order to overcome these drawbacks, in a second embodiment of the method subject of the invention, means control the displacement of the ink jet printing assembly and preferably the printing heads, along five axes. For example, the displacement and orientation means along five axes may consist of a robot comprising:
a carrier with three degrees of freedom in translation, which ensures positioning of the printing assembly while allowing horizontal, vertical translations and in depth of the latter,
a wrist with two degrees of freedom in rotation which supports and ensures orientation of the printing assembly, while allowing rotations of the latter about two perpendicular directions.

Thus, the displacement and orientation means may consist of a robot with five motor-driven axes.

Advantageously, the robot comprises five servo-motors respectively associated with the five axes of this robot. It may further comprise at entry:
one or several shape sensors capable of conducting a measurement of the distance between the printing assembly and the surface to be printed,
five encoders of the drive axes in order to be informed on the displacement of the servo-motors,
end-of-travel and origin-locating sensors respectively associated with each axis of the robot.

Thus, the robot may print an image in memory, while checking by means of the sensors, the position of the shape to be printed.

Alternatively, the shape sensor(s) may also allow tracking of the profile and therefore a direct measurement of the depth relatively to the surface. This measurement process may be achieved automatically, by means of a mechanical feeler. A meshing (more or less fine meshing depending on the complexity of the surface) which describes this depth at different locations is then obtained. This measurement process may take several tens of minutes.

The shape sensors may also be of the optical type, and determine the relief of the surface to be printed, control the displacement of the printing elements so that the ends of the latter, which include the projection nozzles, are always at the same distance from the surface.

As an example, a laser may also check the distance relatively to the surface to be printed, and stop the printing if this distance is less than a safety distance.

### Unit for Controlling the Displacement Means

Advantageously the displacement means described above, which may be designated as a [symbol] robot [symbol] are controlled by a device for pre-positioning and then controlling the print heads in real time, which comprises:
a central unit module,
at least one module for controlling the axes,
a digital input/output module.

Advantageously, the printing of the pattern to be printed on the object will be accomplished in two steps:
a first step comprises the control of the actual positioning of the object in space relatively to a virtual prerecorded 3D image. The robot will seek by laser measurement the reference points on the actual object in order to adjust the reference marks of the virtual 3D image of the object to these actual reference marks.
a second step comprises the supervision of the robot by ensuring coordination between the displacement of the robot and the ink jet printing of the pattern on the virtual prerecorded 3D image of the object and therefore because of the previous step, on the actual object.

This second step may be safely accompanied by a device for laser measurement of the object/printing head distance which will ensure the consequences of an accidental shift in the positioning between the actual object and its virtual 3D image considered by the robot.

The general algorithm for controlling the robot may be the following:

| | |
|---|---|
| 01 - | Loading the digital image to be printed |
| 02 - | Cutting out the image into N [symbol] Sub-Assemblies [symbol] |
| 03 - | Breaking down each [symbol] Sub Assembly [symbol] into binary images. |
| 04 - | Initialization of the robot |
| 05 - | Positioning of the carrier relatively to the reference points on the |

surface of the object.

| | |
|---|---|
| 06 - | Positioning the assembly of the printing heads relatively to the |

actual position of the object

| | |
|---|---|
| 07 - | BEGIN printing |
| 08 - | WHILE No-Current_Sub_Assembly<N |
| 09 - | DO |
| 10 - | BEGIN servo-control of the vertical movement of the robot. |
| 11 - | BEGIN printing of the current Sub-Assembly |
| 12 - | IF distance/support <3mm |
| 13 - | THEN Servo-control OK |
| 14 - | ELSE correction of the distance/support |
| 15 - | WHILE (End-Sub-Assembly not attained) |
| 16 - | IF (End-Sub-Assembly not attained) |
| 17 - | THEN |
| 18 - | STOP printing |
| 19 - | END of Servo-control |
| 20 - | ELSE |
| 21 - | Displacement to the beginning of the next Sub-Assembly |
| 22 - | Printing OK: Return the robot to the rest position. |

This type of control unit is common for one skilled in the art. Thus it is possible to use a control unit as described in the document published under the number US1010/0017085.

### Ink Composition

The above ink composition has a viscosity preferably comprised between 5 and 40 mPa·s and even more preferably comprised between 10 and 25 mPa·s at 20° C.., measured with a viscosimeter of the Brookfield® type.

The resin may be a heat-cured resin, or [symbol] thermosetting [symbol] resin, and in particular among thermosetting resins, those comprising epoxy, isocyanate or acid units are preferred, which lead to obtaining heat-cured networks of the epoxy, polyurethane or ester type.

When the selected resin is a thermoplastic resin, preferably, the weight ratio of the thermoplastic resin to the plasticizer is comprised between 1:0.1 and 1:2, and preferably comprised between 1:0.5 and 1:1. With this ratio it is possible to obtain a particularly abrasion-resistant resin.

The thermoplastic resin(s) may be selected from polyvinyl chloride, chlorinated polyvinyl chloride (CPVC), vinyl chloride copolymers, for example copolymers of vinyl chloride and of vinyl acetate, and polyvinylidene fluoride.

Advantageously, polyvinylchloride and methyl polymethacrylates and copolymers of vinyl chloride and of vinyl acetate are selected.

Preferably, the thermoplastic resin is a polyvinyl chloride (or PVC) resin which may be obtained by an emulsion, suspension or microsuspension method. As an example mention may be made of the resin marketed under the name of Pevikon® P1510 by INEOS.

Preferably, the ink composition comprises by weight based on the total weight of the composition:
5 to 20%, and preferably 10 to 15% of at least one thermoplastic resin, the particles of which have a size comprised between 0.1 and 10 μm, preferably comprised between 0.1 and 5 pm and most preferably comprised between 0.1 and 1 μm,
1 to 20%, and preferably 5 to 15% of at least one coloring agent,
5 to 20%, and preferably 10 to 15% of at least one plasticizer, and
45 to 75%, and preferably 50 to 70% of at least one organic solvent.

The inventors have shown in Example 3 that an ink for which the composition is given above, may be projected through printing heads with a small diameter, and for example with a diameter of 40 μm, and even with a diameter of 30 μm or 20 μm in order to obtain a printed surface of great quality. It is thus possible to obtain a 360 or 720 dpi print in one or two passages of the printing head over a support.

In the sense of the present invention, by coloring agent is meant any compound which may modify the visual aspect of the molded objects, and notably pigments.

The pigment(s) used may be both organic and inorganic. As an example, mention may be made of metal oxides, either coated or not, such as for example titanium oxides (amorphous or crystallized in the rutile and/or anatase form), iron, zinc, zirconium or cerium oxides and mixtures thereof.

Mention may notably be made of the yellow pigment marketed by CIBA under the name of Cromophtal® Yellow PV H3R, titanium dioxide marketed by Kronos® under the name of KRONOS® 2220, the blue pigment marketed by CIBA under the name of Cromophtal® 4GNP and mixtures thereof.

The flakes are generally used for making the object more aesthetical. The flake content in the manufactured object is generally comprised between about 5 and about 50 g/cm². Flakes based on titanium oxide covered with mica are preferably used.

The pigment applied in the composition subject of the invention may appear in the form of a pigment paste, comprising a mixture of pigment and of solvents or a mixture of pigment and of plasticizer, optionally mixed with a dispersant agent.

The plasticizer applied in the composition subject of the invention is a plasticizer compatible with the thermoplastic resin. The plasticizer may be selected from esters formed from an alcohol and an organic acid such as trimellitic acid, sebacic acid, adipic, phthalic, citric, benzoic, tallic, gluatric, fumaric, maleic, oleic, palmitic and acetic acid. Notably, the plasticizer may be selected from octyl trimellitate, dioctyl phthalate, nonyl undecyl phthalate, dioctyl adipate, tricresyl phosphate, trimethyl pentanyl diisobutyrate and mixtures thereof.

Most often, phthalates and trimellitates are used, in particular octyl trimellitate.

As an example mention may be made of the products marketed by POLYNT under the name of Diplast® TM/ST, and Diplast® TM79, of the products marketed by ADEKA PALMAROLE, under the name of CIZER® CBL, and the products marketed by EASTMAN under the name of TXIB®.

Mixtures of these products may be used as a plasticizer.

The organic solvent applied in the composition subject of the invention is a solvent for which the boiling temperature is preferably at least equal to 200° C. The use of such a solvent gives the possibility of avoiding too fast vaporization when the application of the composition subject of the invention is applied on a molded part, and of thus avoiding that operators be in contact with volatile organic compounds.

Preferably, the organic solvent is selected from isophorone, pentyl acetate, alkyl lactates, in particular ethyl lactate, dibasic esters of adipic, glutaric and succinic acids, and mixtures thereof, in particular the mixtures of dimethyl adipate, dimethyl glutarate and dimethyl succinate.

As an example of a solvent, mention may be made of the product marketed by EXXONMOBIL under the trade name of EXXSOL D140®.

In order to vary the viscosity in the ranges defined above, a flow additive may be added. In particular, it may be necessary to lower the viscosity of the composition subject of the invention by using a viscosity lowering agent. This may be a volatile diluent, an emulsifier or a protective colloid. The diluents may in particular include hydrocarbons with a low boiling point such as C₁₀-C₁₆ hydrocarbons. The emulsifiers include salts or esters of fatty acids, condensates of ethylene oxide with phenyl alkyls, or fatty alcohols, zinc/magnesium octoate. The protective colloids are lecithins for example. The amount of flow additive added into the composition subject of the invention is generally from 5 to 100 parts by weight for 100 parts by weight of thermoplastic resin.

As an example of a flow additive, mention may be made of the esters of carboxylic acids marketed under the trade name VISCOBYK 5100® by BYK CHEMIE GmbH.

The ink composition may further comprise one or several additives of additives, selected from fillers, stabilizers, anti-oxidants, application additives, lubricants or flame retarding agents. In particular, among the additives commonly used in composition based on vinyl resin, mention may be made of metal salts of an organic carboxylic acid, of organic phosphoric acid, zeolites, hydrotalcites, epoxide compounds, beta-diketones, polyhydric alcohols, phosphorus-containing, sulfur-containing or phenolic anti-oxidants, ultraviolet absorbers for example benzophenones, benzotriazoles, and oxanilide derivatives, cyanoacrylates, light stabilizers with hindered amines or [symbol] HALS [symbol] for [symbol] hindered amine light stabilizer [symbol] stabilizers with hindered alkoxyamine or [symbol] NOR HALS [symbol] for [symbol] Alkoxyamine hindered amine light stabilizer [symbol] notably the products marketed by Clariant under the name of Hostavin Now®, salts of perchloric acid, and other inorganic compounds based on metals, lubricants for example organic waxes, fatty alcohols, fatty acids, esters, metal salts, fillers for example chalk or talcum, expansion agents for example azodicarbonamides.

As indicated above, the ink composition is intended to be applied in a method for obtaining a printed object, which preferably is a molded object.

The object of the invention is therefore also a molded object comprising a composition as defined above. By molded object, is meant in the sense of the present invention an object obtained from a mold. As an example, said object may be selected from a vehicle dashboard part, a leather goods article, or a saddle.

The molded objects comprising a composition as defined above may be intended for all fields in which it is sought to produce molded objects, in particular molded objects imitating leather, and notably may be intended for the manufacturing of parts for the passenger compartment of an automobile vehicle, door frames, the central console and the armrests, a leather goods article, preferably a handbag, a travel bag and pieces of furniture.

### PREFERRED EMBODIMENTS OF THE METHOD

A preferred embodiment of the method object of the invention, the step (a) comprises the following successive sub-steps:
digitization of an image to be printed and/or digitization of the object on which said image is printed,
cutting out the image to be printed into sub-units such as polygons,
positioning a support relatively to the ink jet printing assembly,
initialization of the means for displacing the ink jet printing assembly, and for their positioning relatively to the surface of the support, in the location where the printing of the image should begin,
printing the image, and
returning to a rest configuration.

The step for digitization of the object on which said image is printed, may be carried out by a 3D scanning method as for example described in the international application published under the number WO2010/015086.

The method subject of the invention may further comprise the following additional steps:
(b) heating the object obtained in step (a) until the ink has gelled or hardened,
(c) depositing on the object obtained in (b), a layer of composition (B) comprising a thermoplastic resin or a mixture of thermoplastic resin, and
(d) heating the mold until the composition (B) has gelled.

During step (b), the temperature of the mold gradually increases, this gradual increase in the temperature allowing gelling of the ink.

By gradual increase in the temperature is meant a heating rate at most equal to 40° C. per minute.

The gelling temperature is generally comprised between 150° C. and about 300° C. It is selected according to the nature of the thermoplastic resin to be transformed.

Thus, preferably, the ink applied during step (a) comprises a polyvinyl chloride resin, and during step (b) the mold is heated up to a temperature comprised between 180° C. and 260° C., and preferably between 230° C. and 300° C.

Thus, preferably, during step (b), the temperature of the mold partly or totally covered with the ink passes from about 40° C. to about 240° C., and the ink is gelled during this rise in temperature.

The composition (B) comprises a thermoplastic resin preferably selected from polyvinyl chloride (PVC) or a mixture of PVC and of a compatible polymer selected from the copolymers or terpolymers of vinyl chloride and of vinyl acetate (VC/VA) or of vinyl chloride and of an acrylic derivative (VC/DA), thermoplastic polyurethanes (TPU), thermoplastic polyetheresters, ethylene/vinyl monomer copolymers (EVA), ethylene/vinyl monomer/carbonyl terpolymers, acrylic elastomers which may be processed in the molten state, copolymers with polyamide blocks and polyether blocks or polyether block amides, chlorinated or chlorosulfonated polyethylenes, ethylene/alkyl (meth)acrylate or (meth)acrylic acid polymers either functionalized or not, core-shell polymers of the MBS type, block SBM terpolymers, PVDF and powder polyamide resins. According to a preferred embodiment of the invention, the thermoplastic resin used is a polyvinylchloride (PVC) with a Kwert comprised between 50 and 80.

According to an embodiment, the thermoplastic resin of the composition (B) is polyvinyl chloride (PVC) obtained by a suspension or micro-suspension method, but PVC made in emulsion or in bulk may also be used; an example of a VC/VA copolymer is Lacovyl® of Arkema, an example of a VC/DA copolymer is Vinnolit® of Vinnolit, an example of a TPU is Estane® from Goodrich, an example of a thermoplastic polyetherester is Hytrel® from DuPont, an example of a polyetherblockamide is Pebax® from Arkema, an example of EVA is Evatane® from Arkema, an example of an ethylene/vinyl monomer/carbonyl terpolymer is Elvaloy® from DuPont, examples of ethylene/alkyl (meth)acrylate or (meth)acrylic acid polymers either functionalized or not are Lotryl®, Lotader® and Orevac® from Arkema, an example of chlorinated or chlorosulfonated polyethylenes is Tyrin® from DuPont, an example of an acrylic elastomer which may be processed in the molten state is Alcryn® from Apa, an example of powder polyamide resins is Orgasol® from Arkema. These polymers compatible with PVC, so-called [symbol] alloys [symbol] have good cold properties and may give suitable brittleness to the layers containing them.

The composition (B) may thus comprise mixtures of thermoplastic resins comprising PVC resins and vinyl chloride or vinyl acetate (VC/VA) or vinyl chloride and acrylic derivative (VC/DA) copolymers or terpolymers, as well as PVC resins and thermoplastic polyurethanes (TPU). These different resins may be mixed together in great proportions.

The composition (B) may also comprise a plasticizer or a plasticizer mixture as defined above. The weight ratio of the thermoplastic resin to the plasticizer in the composition (B) is then comprised between 1:0.1 and 1:2, and preferably comprised between 1:0.5 and 1:1. This ratio gives the possibility of obtaining a particularly abrasion-resistant resin.

During step (c) the composition (B), preferably as powder, may be deposited on the mold following usual molding techniques such as spraying, rotation molding, [symbol] slush-molding [symbol] or slush-casting.

Spraying consists of depositing a powder on the mold, based on an electrostatic effect. Rotation molding consists of applying a strictly required amount of powder in the mold while applying rotary movements of the mold, which allows the mold to be deposited on the surface of the mold. When an amount of powder greater than what is necessary for rotary deposition is introduced into the mold, the excess amount after deposition of the powder on the mold may be removed by gravity. This technique is known under the name of [symbol] slush-molding [symbol] or slush-casting. This latter deposition technique is particularly preferred. In [symbol] slush-molding [symbol] , the composition (B), as a powder, is deposited on the mold totally or partly coated with the ink by rotation of the whole of the device which comprises the mold as well as the reservoir allowing the composition (B) to be deposited. The number of rotations of the device is selected depending on the thickness of the desired composition (B) layer.

Generally, the composition (B) is deposited on the mold at the gelling temperature of the ink. The composition (B) advantageously as a powder is therefore poured or applied onto the mold at a temperature comprised between 150° C. and 300° C., preferably between 180° C. and 260° C., and most preferably between 230° C. and 250° C. During the application of the composition (B) on the mold, the temperature of the mold may decrease down to a temperature comprised between 130° C. and 190° C.

In order that the composition (B) layer properly adheres to the mold partly or totally coated with the ink, the temperature for application of the composition (B), said powdering temperature, should be comprised in the ranges defined above. Indeed, during step (c), the first grains of composition (B) which fall onto the mold, should rapidly gel and adhere to the mold. The following grains adhere to the first and also gel by mixing their PVC chains with those of the surrounding grains (interpenetrations of PVC chains).

If the temperature is too low, the first grains cannot begin to gel therefore they will not adhere to the shell. The PVC resin grains will not adhere together: a poorly gelled porous structure would be obtained.

During step (d), the mold is heated until gelling of the composition (B) i.e. preferably up to a temperature comprised between 150° C. and 300° C. It is selected depending on the nature of the thermoplastic resin to be transformed. Thus, for polyvinyl chlorides, it is advantageously comprised between 180° C. and 260° C., and preferably between 230° C. and 250° C.

At the gelling temperature, it is possible either to carry out again one or several times the steps (c) and (d) or wait for total gelling of the thermoplastic resin before cooling the mold, for example by immersing the latter in water at room temperature.

Any type of mold allowing gradual heating in the presence of a thermoplastic resin may be suitable for the method according to the present invention. Advantageously, jacketed molds with circulation of a heat transfer fluid are used.

Steps (a) and (b) may be separated in time and in space, so that the steps (a) may take place on a production site different from the one on which step (b) and the following steps are carried out.

The method according to the present invention may be applied in the field of decoration and of pigmentation with savings as regards ingredients. It also allows improvement in the touch of the surface of the thereby manufactured objects. Further, it allows improvement in the adhesion between the two layers based on thermoplastic resins of different nature.

The invention will be better understood by means of the following examples.

### EXAMPLE 1

### White Formulation for Printing

An ink composition (white ink) is prepared by mixing the various constituents shown in Table 1 below, according to techniques known to one skilled in the art in the formulation and preparation of inks.

The plasticizer, the stabilizer, the viscosity lowering agent and the solvents are first of all mixed for 5-10 mins at 1,000 rpm by means of a disperser.

The PVC resin is then gradually introduced into the mixture; the introduction time is comprised between 2 and 5 minutes at 500 rpm.

Warming of the mixture is often observed because of the shearing stresses. The mixture is therefore preferentially prepared in a mixer, the temperature of which is controlled (T=23° C.). In order to control the temperature, it is also possible to vary the stirring rate in the disperser.

The viscosity lowering agent is introduced before the PVC resin in order to obtain a marked effect for reducing the viscosity. The viscosity lowering agent may also be introduced right at the end of the ink manufacturing method, with an introduction time of 10 minutes, with stirring at 500 rpm, but the viscosity reduction effect would be less.

It would have been possible to introduce the stabilizer right at the end of the method for manufacturing the ink, with an introduction time of 5 minutes, with stirring at 500 rpm.

A resin dispersion is obtained.

The solvents may also be introduced before and/or after the resin or partly introduced before and after the resin.

The white pigment is then introduced into the mixture as a powder, with an introduction time of 30 minutes, with stirring at 500 rpm.

TABLE 1
Composition according to the invention (white ink)

| White base | | |
|---|---|---|
| for PVC ink | | Amount (in grams) |
| PVC Resin | Pevikon ® P1510 (INEOS) | 15 |
| Plasticizer | Trimellitate Diplast ® TM79 | 9 |
| | (POLYNT) | |
| Solvents | Isophorone (BRENTAG) | 20 |
| | Pentyl acetate (BRENTAG) | 22 |
| | Exxsol ® D140 (EXXXONMOBIL) | 21 |
| Viscosity | Viscobyk ® 5100 (BYK CHEMIE) | 5 |
| control | | |
| agent | | |
| Thermal | Lastab ® 375 T (LAGOR) | 0.5 |
| stabilizer | | |
| Titanium | SACHTELEBEN RDI-S ® | 7.5 |
| Oxide TiO₂ | (SACHTELEBEN) | |

### EXAMPLE 2

### Measurement of the BROOKFIELD® Type Viscosity and of the Particle Size

For an ink jet application, the viscosity measured at 20° C. by means of a Brookfield viscosimeter should be less than 30 mPa·s and preferably less than 20 mPa·s.

The viscosity of the composition of Example 1 was measured at 23° C. by means of a BROOKFIELD DV-II+ Pro® viscosimeter at 60 rpm. The viscosity is 11.1 mPa·s.

The size of the particles present in the composition of Example 1 was measured. The particles have a diameter of less than 2 pm.

### EXAMPLE 3

### Printing Test (Step (a) of the Method Subject of the Invention)

The composition according to the invention (Example 1) is printed on a mold with the use of a piezoelectric ink jet printer equipped with a Xaar Omnidot® 760 GS8 printing head (from Xaar, Cambridge, United Kingdom). The achieved printing types are the following:
Test 1: a predefined pattern is printed on a mold, in a single passage at 360 dpi. A printed pattern is obtained having good resolution, i.e. a very sharp pattern contour, but the opacity of which may be more significant.
Test 2: A predefined pattern is printed on a mold, in two passages at 360 dip. The thickness of the deposited ink is larger than for the Test 1, the obtained pattern is therefore more opaque than for Test 1, and the contour of the pattern is a little less sharp.
Test 3: A predefined pattern is printed on a mold, in a single passage at 720 dpi. The obtained pattern is more opaque than for Test 1, and the contour of the pattern is very sharp. The quality of the printing is even better than for Tests 1 and 2.

### EXAMPLE 4

### Printing Test (Steps (b) to (d) of the Method Subject of the Invention

The mold printed beforehand from Test 3 is used for carrying out the [symbol] slush-molding [symbol] or slush casting.

In a hot air oven, T=295° C., the mold is heated for 4 minutes.

After 4 minutes of heating, the mold is taken out of the oven and plasticized PVC powder is spread out onto the surface. The temperature of the mold is then 210° C.

The mold is then handled so as to ensure homogeneous distribution of the powder over the surface.

Twenty seconds after pouring the powder on the mold, the excess of non-gelled powder is removed by turning the mold upside down. The mold is then covered with a layer of plasticized PVC powder during gelling; it is reintroduced into the oven for 70 seconds of heating.

After this step for gelling the plasticized PVC powder, the mold is taken out of the oven and immersed in a cold water reservoir (T=23° C.) for 90 seconds.

The mold is then dried by spraying compressed air and the thereby achieved skin is removed from the mold.

A plasticized PVC skin which has a printed pattern is obtained.

### EXAMPLE 5

### Color Juxtaposition Tests

Red ink is used in this example. Its composition is similar to the formulation given in Example 1, but the titanium oxide pigment is replaced with 2% of Red pigment Number 214 marketed under the name of [symbol] Fast Red BNP [symbol] by Clariant.

The printing test on Example 3 is then repeated by juxtaposing a second printing head supplied with red ink beside the previous printing head supplied with white ink.

A predefined 2-color pattern is then printed on a mold, in a single passage at a definition of 360 dpi.

A PVC skin is then made by repeating the operating procedure described in Example 4.

The red and white printed pattern has good opacity. The quality of the printing of both inks is good with excellent contrast obtained by clear separation at the interface of the patterns of both colors.

1. A method for obtaining an object having a printed three-dimensional surface, said method comprising at least one step (a) for driving an ink jet printing assembly, said printing assembly being equipped with means for displacement and orientation along several axes, and with at least one unit for controlling these means, and characterized in that said ink is an ink composition comprising, based on the total weight of the composition, 5 to 20% and preferably 10 to 15% of at least one heat-cured or thermoplastic resin, the particles of which have a size comprised between 0.1 and 10 μm.

2. The method according to claim 1, characterized in that the thermoplastic resin is a polyvinyl chloride resin.

3. The method according to claim 1, characterized in that the ink composition further comprises, by weight based on the total weight of the composition:
1 to 20%, and preferably 5 to 15% of at least one coloring agent,
5 to 20%, and preferably 10 to 15% of at least one plasticizer, and
45 to 75%, and preferably 50 to 70% of at least one organic solvent.

4. The method according to claim 1, characterized in that the heat-cured resin is a polyurethane.

5. The method according to claim 3, characterized in that the solvent is selected from isophorone, pentyl acetate, alkyl lactates and preferably ethyl lactate, dibasic esters of adipic, glutaric and succinic acids and mixtures thereof.

6. The method according to claim 1, characterized in that the ink jet printing assembly comprises printing heads with a diameter of less than or equal to 40 μm and preferably comprised between 20 μm and 30 μm.

7. The method according to claim 1, characterized in that the ink jet printing assembly comprises at least one piezoelectric printing head allowing printing by projection of ink drops on demand.

8. The method according to claim 1, characterized in that means control the displacement of the ink jet printing assembly and preferably of the printing heads along 5 axes.

9. The method according to claim 1, characterized in that step (a) comprises the following successive sub-steps;
digitizing an image to be printed and/or digitizing the object on which said image is printed,
cutting out the image to be printed into sub-units such as polygons,
positioning a support relatively to the ink jet printing assembly,
initializing the means for displacing the ink jet printing assembly, and their positioning relatively to the surface of the support, in the location where the printing of the image should begin,
printing the image, and
returning to a rest configuration.

10. The method according to claim 1, characterized in that it comprises the following additional steps:
(b) heating the object obtained in step (a) until gelling or hardening of the ink,
(c) depositing on the object obtained in (b) a layer of composition (B) comprising a thermoplastic resin or a thermoplastic resin mixture, and
(d) heating the mold until gelling of the composition (B).
